(19) United States
(12) Patent Application Publication
(10) Pub. No.: US 2011/0112716 A1
(43) Pub. Date: May 12, 2011

(54) APPARATUS FOR CONTROLLING VEHICLE CHASSIS HAVING INTEGRATED FAIL SAFE CONTROLLER

(75) Inventor: Ji-Yoel JOENG, Gwangmyong-shi (KR)

(73) Assignees: Hyundai Motor Company, Seoul (KR); Kia Motors Corporation, Seoul (KR)

(21) Appl. No.: 12/783,306

(22) Filed: May 19, 2010

(30) Foreign Application Priority Data
Nov. 9, 2009 (KR) 10-2009-0107471

(51) Int. Cl. B60W 30/02; B60W 10/20; B60W 50/04; B60W 50/02

(52) U.S. Cl. 701/29; 701/41

(57) ABSTRACT

An apparatus for controlling a vehicle chassis, may include an ESC (Electronic Stability Control) controller for controlling a position of the vehicle chassis, an MDPS (Motor-Driven Power Steering) controller for controlling a motor-driven power steering of a vehicle, an integrated controller receiving sensor signals or data signals from the ECS and MDPS controllers through a communication module of the ESC controller and a communication module of the MDPS controller, and an integrated fail safe controller, wherein the integrated fail safe controller receives the sensor signals or the data signals from the ESC and MDPS controllers through the communication module of the ESC controller and the communication module of the MDPS controller, or ECU (Electronic Control Unit) control signals of the ESC and MDPS controllers, and performs a fail safe function by cross-checking the inputted sensor signals or the data signals, or the ECU control signals of the ESC and MDPS controllers.

### CROSS-REFERENCE TO RELATED APPLICATION

The present application claims priority to Korean Patent Application No. 10-2009-0107471, filed on Nov. 9, 2009, the entire contents of which is incorporated herein for all purposes by this reference.

### BACKGROUND OF THE INVENTION

1. Field of the Invention

The present invention relates to an apparatus for controlling a vehicle chassis while the vehicle travels, in more detail, an apparatus for controlling a vehicle chassis having an integrated fail safe controller that can maximize stability when a vehicle is traveling or braked, by providing an integrated fail safe controller for electronic stability control and motor-driven power steering of the vehicle.

2. Description of Related Art

In general, electronic control systems equipped with an ECU (Electronic Control Unit), such as a microprocessor, have been used to more reliably control the position of a vehicle chassis when the vehicle is traveling or braked.

ESC (Electronic Stability Control), one of the electronic control systems for a vehicle, called electronic position control, is also called VDC (Vehicle Dynamic Control System) or ESP (Electronic Stability Programme).

The ESC is a device for preventing a vehicle from deviating the traveling course while avoiding an emergency, such as spin or drift of the vehicle which may occur when the vehicle loses its balance on a curve or a slippery road or by an obstacle suddenly appearing while the vehicle travels, by estimating the turning direction and yaw moment applied when the vehicle, which is traveling, turns while calculating increase or decrease of brake pressure of each wheel on the basis of input values of sensors, such as a steering angle sensor, a velocity sensor, and a G sensor, equipped in the vehicle, and generating moment against the yaw moment or the turn direction by operating actuators, such as a master cylinder pressure port (stopping, increasing, decreasing) and a motor relay. Further, the ESC is usually integrated with a brake control system, such as an ABS (Anti-Lock Brake System).

A motor-driven power steering system called MDPS (Motor-Driven Power Steering) as an electronic control system for a vehicle is known.

The MDPS is a system that drives a motor by electronically controlling a steering force of a steering wheel in accordance with the traveling velocity of a vehicle. Further, it is a system that provides stability in high-velocity traveling by decreasing the steering force when a vehicle is parked or travels at low velocity and increases the steering force when a vehicle travels at high velocity.

The MDPS includes sensors, such as a velocity sensor, a torque sensor, and a motor rotation angle sensor, an actuator, such as a motor, and a controller that controls them, and an optimum steering force of a steering wheel at the corresponding traveling velocity of a vehicle is provided by the controller by driving the motor in response to signals transmitted from the sensors.

In this configuration, control units, such as ESC or MPDS, has a function of fail safe stopping the original function when abnormal conditions or circumstances occur, outside the control range of the control unit.

The fail safe function makes it possible to improve reliability of sensor signals or data signals of a vehicle, which are usually transmitted in a way of CAN (Controller Area Network), by preventing basic causes for abnormal operation that may occur in controlling a vehicle chassis.

FIG. 1 is a block diagram for implementing a fail safe function in an ESC and an MDPS of the related art, in which an ESC controller 20 includes an ECU module 21 performing ESC control, sensor modules 22 for ESC control, such as a steering angle sensor, velocity sensor, and a G sensor, an actuator 23 for ESC driving, such as a master cylinder pressure port or a motor relay, and a communication module 24 communicates sensor signals or data signals with an integrated controller 10 that performs control throughout the vehicle together with the ESC controller 20. The ESC controller 20 is connected with an ESC fail safe controller 40 that stops the function of the ESC controller 20, when abnormal conditions or circumstances occur, outside the control range of the ESC controller 20.

Further, the MDPS controller 30, similar to the ESC controller 20, includes an ECU module 31 performing MDPS control, sensor modules 32 for MDPS control, such as a velocity sensor, a torque sensor, and a motor rotation angle sensor, an actuator 33, such as a motor generating a driving force for controlling a steering force, and a communication module 34 communicating sensor signals or data signals with an integrated controller 10. The MDPS controller 30 is connected with an MDPS fail safe controller 50 that stops the function of the MDPS controller 30, when abnormal conditions or circumstances occur, outside the control range of the MDPS controller 30.

The fail safe function for the ESC and the MDPS of the related art described above was implemented when sensor signal or data signals generated by the ESC controller 20 and the MDPS controller 30 or control signals for controlling the above signals are individually used by each fail safe controller, because the fail safe controllers are individually operated by the ESC controller 20 and the MDPS controller 30.

However, the configuration including individual fail safe controllers as described above cannot perform cross-check between the signals generated by the ESC controller 20 or the MDPS controller 30, such that there is a limit in improving reliability of the sensor signals or the data signals.

Therefore, it have been required to develop a fail safe control device having a configuration that improves stability in braking and steering which are performed by the ESC controller 20 or the MDPS controller 30.

Meanwhile, although a cooperative control method between individual electronic controllers of a vehicle equipped with an integrated controller that performs cooperative control while exchanging information between an ESC controller and an MDPS controller is disclosed in Korean Patent Publication No. 2009-61182, this invention is still limited in improving reliability of sensor signals or data signal, because it is not provided with a function relating to fail safe.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide an apparatus for controlling a vehicle chassis that can improve reliability of sensor signals or data signals when performing a fail safe function of a vehicle while cross-checking signals generated by an ESC controller or an MDPS controller.

In an aspect of the present invention, an apparatus for controlling a vehicle chassis, may include an ESC (Electronic Stability Control) controller for controlling a position of the vehicle chassis, an MDPS (Motor-Driven Power Steering) controller for controlling a motor-driven power steering of a vehicle, an integrated controller receiving sensor signals or data signals from the ECS and MDPS controllers through a communication module of the ESC controller and a communication module of the MDPS controller, and an integrated fail safe controller, wherein the integrated fail safe controller receives the sensor signals or the data signals from the ESC and MDPS controllers through the communication module of the ESC controller and the communication module of the MDPS controller, or ECU (Electronic Control Unit) control signals of the ESC and MDPS controllers, and performs a fail safe function by cross-checking the inputted sensor signals or the data signals, or the ECU control signals of the ESC and MDPS controllers.

The integrated fail safe controller may include a plug and play recognition module that recognizes the sensor signals or the data signals that are inputted from the ESC controller and the MDPS controller, or the ECU control signals of the ECS and MDPS controllers.

The integrated fail safe controller may include a control and communication error setting module that controls the sensor signals or the data signals which are generated by the ESC controller and the MDPS controller, or the ECU control signals of the ECS and MDPS controllers, or defines an error condition in communication.

The error condition may be defined by the control and communication error setting module as a circumstance outside a control range of the ESC controller and the MDPS controller.

The integrated fail safe controller may include an operation stop condition setting module that performs operation stop functions to stop the ESC controller and the MDPS controller, when the error condition occurs.

The integrated fail safe controller may include a DTC (Diagnostic Trouble Code) generating module that generates circumstance information when a circumstance corresponding to the operation stop conditions of the ESC controller and the MDPS controller continues, to use the circumstance information for improvement later.

The integrated fail safe controller may include a bad condition setting module that sets a reference range of a signal that cannot be controlled by the ESC controller and the MDPS controller, and performs operation stop functions to stop the ESC controller and the MDPS controller, when a signal within the reference range is inputted from the ESC controller and the MDPS controller.

According to the apparatus for controlling a vehicle chassis having an integrated fail safe controller configured as described above, since the integrated fail safe controller performs a fail safe function by cross-checking the sensor signals or the data signals that are generated by the ESC controller and the MDPS controller, or the ECU control signal, it is possible to improve reliability of the sensor signals, data signals, or the ECU control signals, and it is also possible to achieve improved braking distance of the vehicle, braking stability, and handling performance in steering, by the integrated fail safe control of the ESC controller and the MDPS controller.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a block diagram for implementing a fail safe function in an ESC controller and an MDPS controller of the related art.

FIG. 2 is an exemplary diagram illustrating the configuration of an apparatus for controlling a vehicle chassis having an integrated fail safe controller of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The configuration of an apparatus for controlling vehicle chassis having an integrated fail safe controller in an exemplary embodiment of the present invention is described hereafter in detail with reference to the accompanying drawings.

The terminologies used herein, if not stated, have the meanings that those skilled in the art generally understand, and known technologies and configurations that may make the spirit of the present invention unclear are not described in the following description and the accompanying drawings.

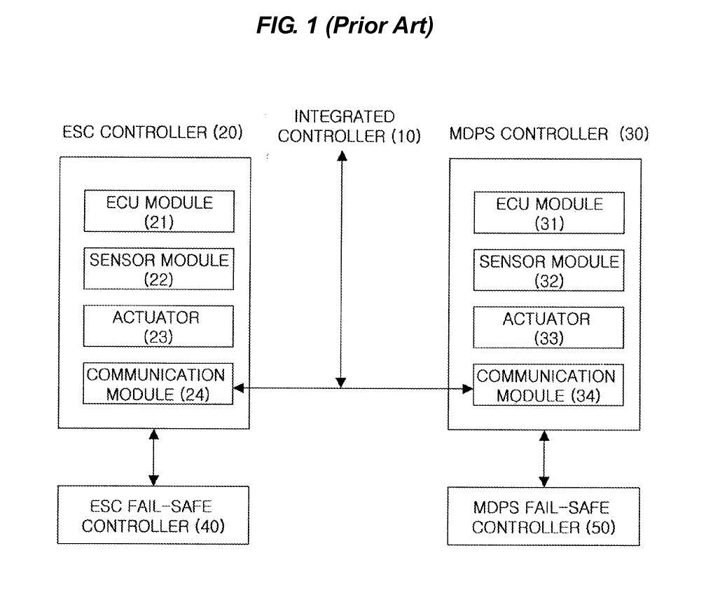

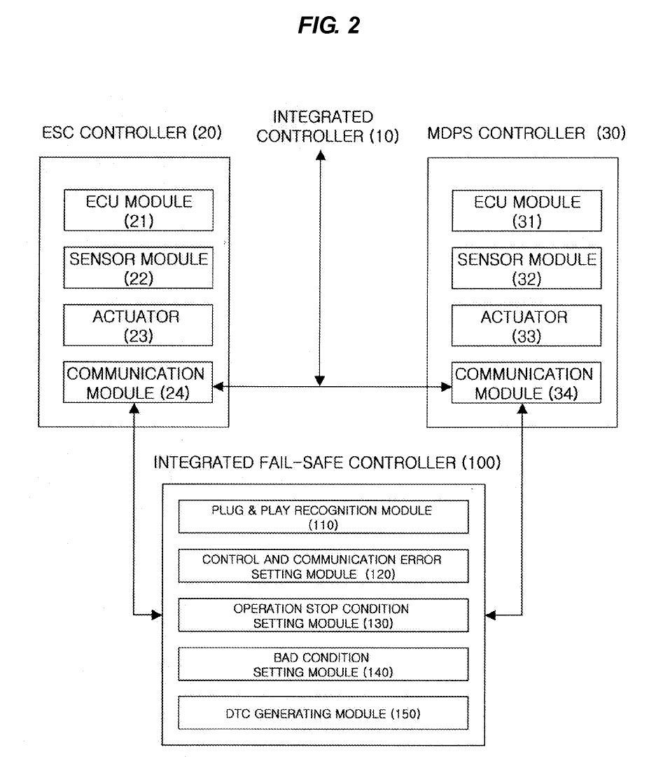

FIG. 2 is a diagram illustrating the configuration of an apparatus for controlling a vehicle chassis having an integrated fail safe controller in an exemplary embodiment of the present invention, in which the same parts as in the configuration shown in FIG. 1 are designated by the same reference numerals.

An apparatus for controlling a vehicle chassis having an integrated fail safe controller in an exemplary embodiment of the present invention includes the ESC controller 20 and the MDPS controller 30, which are shown in FIG. 2, in which the ESC controller 20 includes an ECU module 21 performing ESC control, sensor modules 22 for ESC control, such as a steering angle sensor, a velocity sensor, and G sensor, an actuator 23 for ESC driving, such as a master cylinder pressure port or a motor relay, and a communication module 24 communicating sensor signals or data signals with an integrated controller 10 that performs control throughout the vehicle together with the ESC controller 20.

Further, the MDPS controller 30 includes an ECU module 31 performing MDPS control, sensor modules 32 for MDPS control, such as a velocity sensor, a torque sensor, and a motor rotation angle sensor, an actuator 33, such as a motor generating a driving force for controlling a steering force, and a communication module 34 communicating sensor signals or data signals with an integrated controller 10.

Further, the ESC controller 20 and the MDPS controller 30 are connected with an integrated fail safe controller 100 that stops the function of the ESC controller 20 or MDPS controller 30, when abnormal conditions or circumstances occur, outside the control range of the ESC controller 20 or the MDPS controller 30.

The integrated fail safe controller 100 receives sensor signals or data signals which are communicated to the outside of the controllers 20 and 30 through a communication module 24 of the ESC controller 20 and a communication module 34 of the MDPS controller 30.

The integrated fail safe controller 100 receives control signals, which are generated by the ECU module 21 of the ESC controller 20 and the ECU module 31 of the MDPS controller 30, through the communication modules 24 and 34.

Further, the integrated fail safe controller 100 improves reliability of the sensor signal or data signals, which are inputted through the communication modules 24 and 34 from the ESC controller 20 and the MDPS controller 30, or ECU control signals, by cross-checking the sensor signals, data signals, or the ECU control signals.

The integrated fail safe controller 100, as described above, includes modules for cross-checking signals.

A plug and play recognition module 110 is a module that automatically recognizes the sensor signals or data signals, which are inputted from the ESC controller 20 and the MDPS controller 30, or the ECU signals.

A control and communication error setting module 120 is a module that controls the sensor signals or the data signals, which are generated by the ESC controller 20 and the MDPS controller 30, or the ECU control signals, or defines error conditions in communication.

An operation stop condition setting module 130 is a module that sets a function, which is stopped, in the functions of the ESC controller 20 and the MDPS controller 30, when an error condition, such as an abnormal condition or circumstance outside the control range of the ESC controller 20 and the MDPS controller 30, under the error conditions defined by the control and communication error setting module 120 occurs.

A bad condition setting module 140 is a module that sets a reference range of a signal that cannot be controlled by the ESC controller 20 and the MDPS controller 30, and stops the functions of the ESC controller 20 and the MDPS controller 30, when a signal within the reference range is inputted.

A DTC (Diagnostic Trouble Code) generating module 150 is a module that generates circumstance information when a circumstance corresponding to the operation stop conditions of the ESC controller 20 and the MDPS controller 30 continues, to use it for improvement later.

Therefore, since the integrated fail safe controller 100 of the present invention performs the fail safe function by cross-checking the sensor signals or the data signals inputted by the functions performed by the modules described above, or the ECU control signals, it can improve reliability of the sensor signals, data signals, or the ECU control signals.

Further, improved braking distance of a vehicle, braking stability, and handling performance in steering were achieved, as a result of an experiment, by the integrated fail safe control of the ESC controller 20 and the MDPS controller 30, that is, the braking distance was reduced by 5.3% in rapid braking, the braking stability was improved from 6+ grade to 7 grade, and the handling performance in rapid steering on a low-frictional road was improved from 7 to 7+.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An apparatus for controlling a vehicle chassis, comprising:
an ESC (Electronic Stability Control) controller for controlling a position of the vehicle chassis;
an MDPS (Motor-Driven Power Steering) controller for controlling a motor-driven power steering of a vehicle;
an integrated controller receiving sensor signals or data signals from the ECS and MDPS controllers through a communication module of the ESC controller and a communication module of the MDPS controller; and
an integrated fail safe controller,
wherein the integrated fail safe controller receives the sensor signals or the data signals from the ESC and MDPS controllers through the communication module of the ESC controller and the communication module of the MDPS controller, or ECU (Electronic Control Unit) control signals of the ESC and MDPS controllers, and performs a fail safe function by cross-checking the inputted sensor signals or the data signals, or the ECU control signals of the ESC and MDPS controllers.

2. The apparatus according to claim 1, wherein the integrated fail safe controller includes a plug and play recognition module that recognizes the sensor signals or the data signals that are inputted from the ESC controller and the MDPS controller, or the ECU control signals of the ECS and MDPS controllers.

3. The apparatus according to claim 1, wherein the integrated fail safe controller includes a control and communication error setting module that controls the sensor signals or the data signals which are generated by the ESC controller and the MDPS controller, or the ECU control signals of the ECS and MDPS controllers, or defines an error condition in communication.

4. The apparatus according to claim 3, wherein the error condition is defined by the control and communication error setting module as a circumstance outside a control range of the ESC controller and the MDPS controller.

5. The apparatus according to claim 3, wherein the integrated fail safe controller includes an operation stop condition setting module that performs operation stop functions to stop the ESC controller and the MDPS controller, when the error condition occurs.

6. The apparatus according to claim 5, wherein the integrated fail safe controller includes a DTC (Diagnostic Trouble Code) generating module that generates circumstance information when a circumstance corresponding to the operation stop conditions of the ESC controller and the MDPS controller continues, to use the circumstance information for improvement later.

7. The apparatus according to claim 1, wherein the integrated fail safe controller includes a bad condition setting module that sets a reference range of a signal that cannot be controlled by the ESC controller and the MDPS controller, and performs operation stop functions to stop the ESC controller and the MDPS controller, when a signal within the reference range is inputted from the ESC controller and the MDPS controller.

8. The apparatus according to claim 7, wherein the integrated fail safe controller includes a DTC (Diagnostic Trouble Code) generating module that generates circumstance information when a circumstance corresponding to the operation stop conditions of the ESC controller and the MDPS controller continues, to use the circumstance information for improvement later.
